(19) United States
(12) Patent Application Publication
(10) Pub. No.: US 2008/0183328 A1
(43) Pub. Date: Jul. 31, 2008

(54) Laser Guided System for Picking or Sorting

(76) Inventor: Darin L. Danelski, Oconomowoc, WI (US)

Correspondence Address: REINHART BOERNER VAN DEUREN P.C., 2215 PERRYGREEN WAY, ROCKFORD, IL, 61107, US

(21) Appl. No.: 11/627,836

(22) Filed: Jan. 26, 2007

(51) Int. Cl. G06F 7/00; G06Q 10/00

(52) U.S. Cl. 700/216; 705/28

(57) ABSTRACT

A laser-guided picking or placing system is provided. The laser guided picking system works with an inventory system including a plurality of items located in particular storage areas, such as drawers or bins. Each particular storage area stores a particular item. A computer system keeps track of the items and quantity stored in each storage location. A light reflector is preferably placed near each storage area, the light reflectors within line-of-sight of a nearby laser light system. When a list of items on a customer order is generated, the computer commands the laser to point to the storage areas of the desired items or to the reflectors corresponding to storage areas, one at a time. A picking specialist then manually picks the desired number of items from each storage area, placing the items in a tote or other container, until the order is complete. Items may also be placed in the bins to replenish inventory or to return items to stock.

### FIELD OF THE INVENTION

This invention generally relates to manual picking and sorting systems in warehouses or other distribution centers.

### BACKGROUND OF THE INVENTION

The rise of Internet sales and the shipping of packages and goods in response to Internet orders has elevated the importance of operations in warehouses. Typically, goods are stored in warehouses and orders are received from buyers through a variety of communications, whether through the Internet or other, more conventional means, such as from mail-order or telephone order intake. The goods are then selected in accordance with the customer's order, and are shipped via delivery or mail service.

It is important to operate distribution centers, their associated warehouses, and the processes for picking or sorting of the ordered goods in an efficient manner. This insures that a high volume of orders can be processed through the warehouse and that operation costs can be kept to a minimum. Product picking for consumer orders is different from order processing for an industrial customer. The number of items picked for consumer orders tends to be rather small, possibly as low as one or two items per order, compared to tens or hundreds of items picked for industrial customers. The number of orders processed per hour to maintain the same return on investment is far greater for consumer sales than for industrial sales. Thus, it is important to have systems and procedures in place to process each order very quickly.

These systems should take into account the need for returning items to stock. Returns take two forms, depending on whether the item is un-opened. Un-opened items are generally returned to stock and are handled as a reverse pick (or put), in which the picking specialist simply returns the item to the proper storage location. Opened items, for return to the manufacturer, are generally handled in a separate area, with locations associated with each manufacturer, rather than for each particular product.

One way to manage orders in such a system is disclosed in U.S. Pat. No. 5,812,986 to Danelski. This patent discloses a picking system in which an order is received and sent to a picking system computer. The system includes a radio-frequency (RF) module on each storage site or bin in the storage system. The computer then sends RF signals to the RF modules corresponding to items on the order. Each RF module signaled corresponds to an item on the order. The signal causes a light on the RF module to be lit and the signal also includes a quantity desired for the order. A picking specialist then surveys the inventory sites, goes to those sites for which a light is lit, picks the desired quantity for the order, and signals that the particular item has been picked. While this method works, it is expensive to provide the modules for each location, and it is also expensive to maintain and power the modules.

Another system, disclosed in U.S. Pat. No. 6,650,225, offers an improvement over the Danelski system. The improved system includes a proximity detector near at least one of the modules or sites. The detector can report that there was activity sensed in the vicinity of the module, thus inferring that the picking specialist was at least near the module. Another inference that may be drawn is that if no proximity or activity was sensed, the item corresponding to that module or site was not picked, and an error signal may then be generated. While there is some feedback in this disclosure, it would appear to work best at determining if a picking specialist was near the area, rather than near a particular module.

Another system is disclosed in U.S. Pat. No. 6,775,588. The system disclosed in this patent uses a portable computer on a cart, the cart also having at least two bins for storing goods that are picked. As the operator moves the cart through the warehouse or inventory area, the wireless-equipped computer causes lights on display modules to illuminate. The display module, one per inventory item, illuminates its light in response to a signal from the computer, and also displays an indicia of the order number and quantity, so that the correct number of items can be placed into the correct bin on the cart. The computer can also indicate the desired location of goods to the operator. This system will be expensive, because of the need for modules at each warehouse location, and also because of the required computer and cart to carry out the order-picking process. In addition, there is no feedback or confirmation that a particular item was picked and placed into the tote.

Each of the above systems has its strong points. The weak point for each system, in addition to any technical nuances, is its cost. Embodiments of the invention disclosed in this patent provide a picking system that is both cost-effective and efficient. These and other advantages of embodiments of the invention, as well as additional inventive features, will be apparent from the description provided herein.

### BRIEF SUMMARY OF THE INVENTION

One embodiment is a light-directed inventory system. The light-directed inventory system includes a plurality of storage locations, each of said plurality of storage locations located at an assigned location. The system optionally includes a light reflector adjacent each of the plurality of storage locations, and a laser-light system configured for aiming a beam of visible light to each of the storage locations or to each of the light reflectors. The system includes a computer system in communication with the laser-light system, and the computer system is configured to receive a list of items on an order and to aim the visible light at one storage location or reflector at a time, the reflector corresponding to a storage location with an item on the list of items of the order, wherein the storage locations and the optional light reflectors are configured for line-of-sight communication with the laser-light system.

Another embodiment is a light-directed inventory system. The light-directed inventory system includes a plurality of storage locations, each of said plurality of storage locations located at an assigned location in rows and columns in a horizontal and vertical array, a light reflector adjacent each of the plurality of storage locations, and a laser-light system configured for aiming a beam of visible light to each of the light reflectors. The system also includes a computer system in communication with the laser-light system, the computer system configured to receive a list of items on an order and to aim the laser light system at one reflector at a time in the array, the reflector corresponding to an adjacent storage location with an item on the list of items of the order, wherein the storage locations and the light reflectors are configured for line-of-sight communication with the laser-light system.

Another embodiment is a method for picking or placing items from an array of storage locations. The method includes steps of: providing a tote for picking or placing items; providing an array of storage locations holding items, each storage location in the array optionally having a light reflector adjacent the storage location; providing a list of items and a quantity of each item on the list; sending information to a computer system concerning a quantity of each item on the list of items; operating a laser light system in communication with the computer system to direct visible laser light to a storage location holding an item on the list or to the optional light reflector corresponding to the storage location; and picking a desired quantity of items from the storage location and placing them into the tote, or placing a desired quantity of items from the tote into the storage location.

Other aspects, objectives and advantages of embodiments of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic view of an inventory control system;

FIG. 2 is a perspective view of an array of bins or storage locations;

FIG. 3 is a top view of the array of FIG. 2;

FIG. 4 is an alternate embodiment of a directed laser light system; and

FIG. 5 is a flowchart for a method for picking or placing items.

While the invention will be described in connection with certain preferred embodiments, there is no intent to limit it to those embodiments. On the contrary, the intent is to cover all alternatives, modifications and equivalents as included within the spirit and scope of the invention as defined by the appended claims. The purpose of embodiments of the present invention is to please customers that have ordered consumer products. The distribution center desirably completes the order from stock, quickly, efficiently, and at the minimum cost. In order to satisfy customers, orders must be picked and shipped accurately and as quickly as possible. Customers do not wish to wait and are not happy when the order is inaccurate or incomplete.

### DETAILED DESCRIPTION OF THE PRESENTLY PREFERRED EMBODIMENTS

Embodiments of the laser guided control system are preferably implemented with a computer control over several aspects of the order. For instance, orders from customers preferably are entered by the customer, for example, from a template or order form available on the Internet. Alternatively, orders may be taken over the telephone, or sent in electronically or via facsimile, and then transcribed or entered into a computer by an operator or inside sales personnel. In any event, a list of items desired is preferably generated and sent to a computer system that operates a laser guiding control system or is in communication with the laser guiding control system.

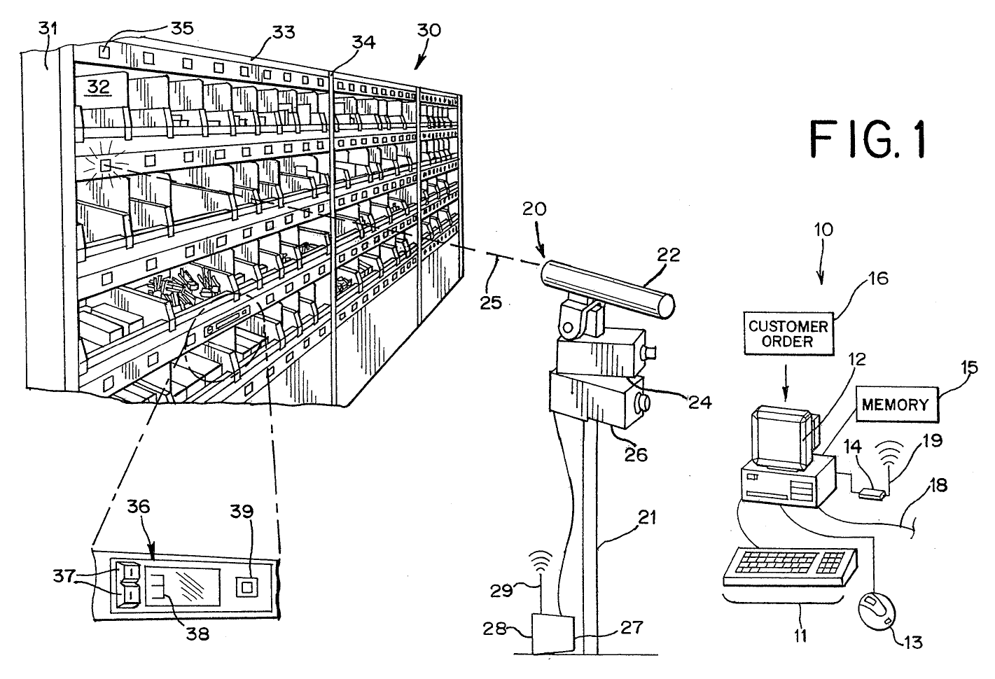

A computer for operating the laser guiding control system is depicted in FIG. 1, along with a laser guiding system and a plurality of storage locations. Computer system 10 may include a keyboard 11 and mouse 13 for inputs to the system, and may also include a display 12, an RF output 14, or other wireless output, or a hard-wired output 18. As noted, customer orders 16 or other lists of items are input to the computer system in one of several possible ways. The computer also includes memory internally, or may also include additional memory in peripheral units 15.

The computer system is in operable communication with a laser light system 20. Laser system 20 includes a mount 21, a visible laser light source 22, and stepper motors and controls for two axes of motion 24, 26, such as pan and tilt. The system 20 may include its own computer control 27, in communication with computer system 10 via hard wire input 28 or wireless communications 29. Pan and tilt systems incorporated stepper motors are available from a variety of sources. The stepper motors ideally have at least four poles, or are controlled by computer so that they be stepped through at least four steps per revolution, i.e., they have multiple “poles” or micro steps for each revolution. More complicated systems may be used, such as pan, tilt, and zoom, but may have few advantages over a simpler, two-axes system. Visible laser light 25 illuminates a particular storage location, or a reflector adjacent the particular storage location.

Another embodiment may use a laser that is fixed in place, while a prism or mirror is maneuvered to direct the laser light to the desired reflector. As shown in FIG. 4, the laser light source 22 may be stationary, while pan and tilt controls 24, 26 adjust the positions of mirrors 23 to direct visible laser light 25 to a bin or storage location 32. In one embodiment, the laser light may simply illuminate a spot, or may indicate a number 25a of items to be picked, as shown. Systems for using prisms or mirrors to achieve visible displays, including the use of total internal reflection (TIR) techniques to achieve tight, 90° turns, are well known in the art. See, e.g., U.S. Pat. No. 6,879,306.

The laser light system 20 is designed and placed so that system 20 can direct the laser light 25 to each location or to each reflector 35 of an inventory system 30. Inventory system 30 includes warehouse storage 31 with a plurality of racks, 33, 34, and a plurality of storage locations 32 on each rack. Each storage location may have a bin, as shown, or the storage location may simply be a designated area on the tiers or shelves of the rack. Each bin or storage location preferably, but not necessarily has a reflector 35 for receiving visible light 25 from the laser light source 22. When laser light illuminates a particular storage location or reflector, an inventory specialist knows that is the bin or storage location from which parts should be picked, or into which parts should be placed. The specialist knows the quantity of parts from a display near the storage location. If reflectors are needed, rather than using the bins themselves, using reflectors, and directing visible laser light to the reflectors, avoids the higher costs of more sophisticated displays, local input devices, and so forth.

Each rack 33 is preferably equipped with a feedback module 36, preferably in a central location on the rack for the convenience of the picking specialist. Module 36 is in communication with computer 12 via hard wire 18 or other method, such as a wireless RF or infrared technique. When the picking specialist has completed a pick from a given storage location 32 in accordance with the desired number of items on display 38, he or she may press “task complete” button 39, thus informing the computer that the inventory should be decremented by that number of items. If there is a discrepancy, such as an insufficient number of items in the given storage location, up or down buttons 37 may be used to indicate the number of items that are still needed. These buttons may also be used when restocking or replenishing stock. In one embodiment, the down button may be used to decrement the display once for each item or stock keeping unit that will be missing from the order; the up button may be used to increment the display for each item re-shelved or used to replenish stock.

The visible laser light used is preferably as low power as possible, in order to avoid unnecessary exposure of employees to laser light. It has been found that a green laser light, Class II, is sufficient in most conditions in warehouses for reliable transmission of light up to 200 feet. Class II devices emit visible light, typically less than 1 mw, that may be viewed safely for short periods of time. This is the power level that is typically used in bar code scanners. Devices that emit green light (about 530 to 560 nm) appear to be brighter, and thus more useful for present purposes, than those emitting red light, such as those used in bar code scanners. Green laser devices are available from a variety of producers, such as StockerYale, of Salem N.H., U.S.A, and Leadlight Technology, Inc., Taipei, Taiwan. Embodiments are not limited to these preferred power levels and colors of laser emitters.

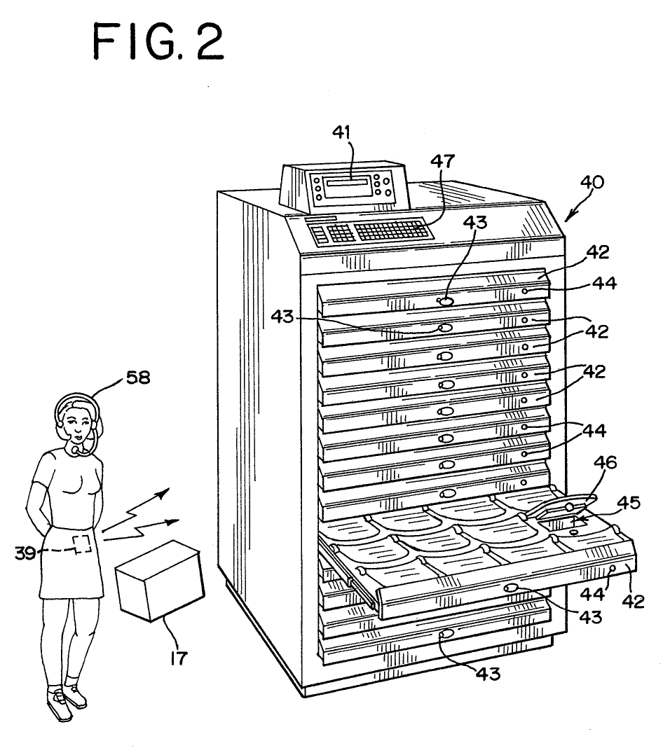

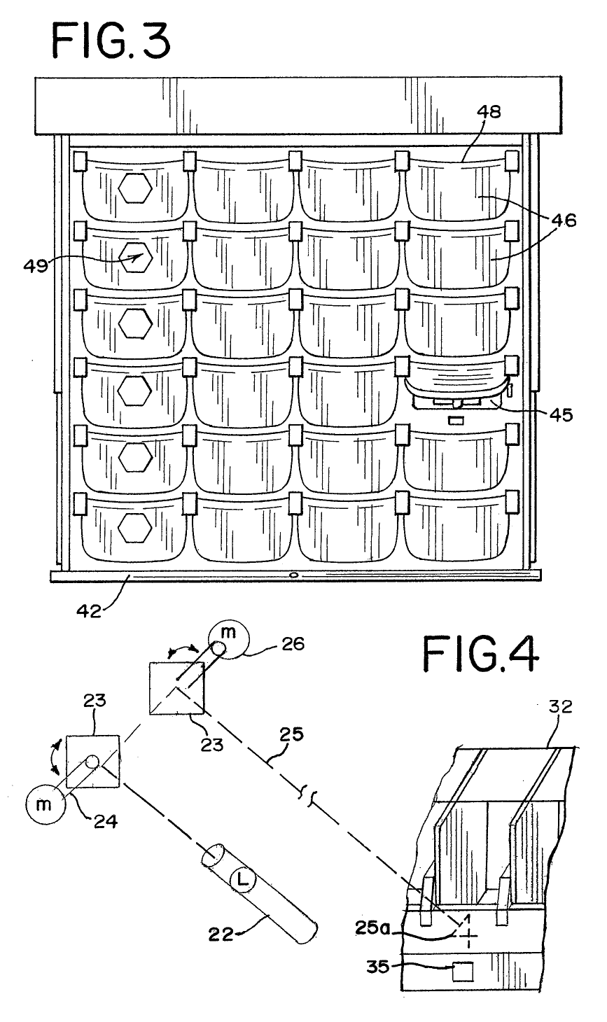

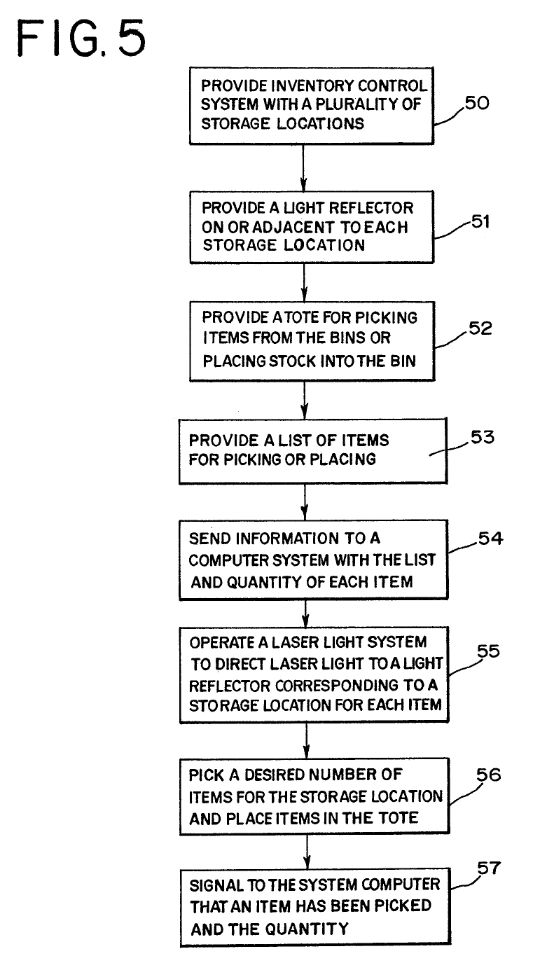

Another embodiment of an inventory system or storage area is depicted in FIG. 2. Storage area 40 includes a computer 41 and a keyboard 47 for making entries into the computer, such as to record or change items or quantities in the inventory. The inventory includes drawers 42, each with a lock 44 and preferably a reflector 43. Inside each drawer is a series of smaller compartments 45, each with a lid 46. As shown in greater detail in FIG. 3, the inside of each drawer 42 with a plurality of compartments 45 and lids 46 also preferably, but not necessarily, includes a reflector 49 atop each lid. The lids may be small doors as shown, opening on hinges 48. This embodiment may be useful when the goods in inventory are valuable, but small in size, such as a variety of grades of jewels. For example, diamonds or other gemstones, each with a separate classification, may be kept in one or more separated, small compartments 45.

In operation, the system computer 10 will aim laser 22 at the reflector 43 of the drawer 42 that holds the desired item. When the inventory specialist opens the drawer, the computer may optionally then aim laser 22 at the desired compartment 45 or lid 46 or the reflector 49 of desired compartment 45 and lid 46. While the reflector will help the picking specialist because of the increased visibility, the reflector in this embodiment, as in other embodiments, is preferable and desirable, but not necessary. The specialist may then select the desired quantity from the appropriate compartment, place the item into a tote 17, and move to the next item on the customer's order list, which list may or may not be reduced to paper, and which may reside on the computer until, for instance, a packing list is prepared. A tote may be any handy container or carton, including a carton in which goods are shipped or are to be shipped, or may be special containers made of paper, wood, plastic, metal, or combinations of these or other materials. The specialist may also indicate to the system computer 10 that the desired quantity has been picked by signaling through module 36 or other feedback device, such as a transmitter with a microphone 58 or a portable computer 59, such as a personal digital assistant (PDA).

A method of using the laser guided picking system is shown in the flowchart of FIG. 4. The method is a manual method used with an inventory control system having a plurality of storage locations 50. Each storage location is provided with a light reflector 51. The inventory specialist uses a tote or other container 52 to pick items on a pick list 53. The pick list will most often come from a customer order, such as a customer ordering from a catalog or over the Internet. The list is sent to a system computer or otherwise converted so that the list corresponds to items in inventory, and in particular to a list of items and a quantity desired of each item 54. The computer system, or a separate computer system, then operates a laser light system to direct laser light to a light reflector corresponding to a storage location for each item 55. The inventory specialist then goes to the indicated storage location and picks the desired quantity of the particular item, and places the items in the tote 56. The specialist then signals to the computer that the item has been picked 57, and preferably also indicates the quantity picked. If the quantity is less than the desired quantity, the system computer can make a note to the customer that the item is out of stock, and the system can then back-order the item.

The above system may be considered a “pick-to-light” system, since the person who is picking moves from one storage area to the next as indicated by the moving light. Of course, inventory must occasionally be replenished, or items returned to stock. In some embodiments, it may be just as efficient to use a tote or other container, and possibly a list, to instead place items into the desired bins or storage areas. The process described above is repeated; when items are placed into the bins, it may be known as a “put-to-light” system.

In some embodiments, a warehouse or inventory storage area may have more than one rack 31. There may be several racks in a row, such as two or three racks, or more, so long as the laser light may reliably reach each reflector so that the picker or inventory specialist can discern which reflector is being illuminated. We have found that about 200 feet is the practical limit for reliable discernment of laser light reflection using Class II, 532 nm illumination. If the warehouse or inventory is larger, the racks may be arranged in a circular or semi-circular manner. In other embodiments, there may be more than one row of racks, and more than one laser light system so that each rack and reflector may be within line of sight of a laser system.

It is helpful, but not necessary, to provide feedback to the computer system that the correct quantity of an item has been picked. This feedback desirably takes place during the picking process, so that when an inventory specialist signals to the system that an item on the list has been picked, the signal may include an indication of the quantity that has been picked. To communicate with the system, the modules placed at various locations in the warehouse described above with the up and down buttons and a “task complete” button may be used. Alternatively, the picking specialist may have a communications and feedback tool, such as a PDA or a voice-activated radio headset. When an item has been picked, the specialist may indicate successful completion of the pick, and the indication may also include a positive indication of the quantity.

For example, after picking an item, the specialist may depress a number key and a function or other key for which the computer has been programmed to understand, “item picked.” A transmission of “4, enter,” may indicate a successful pick of 4 of the item corresponding to the presently-illuminated reflector. In other embodiments, each rack or area may include a switch, a module, or a computer, as described above, in communication with the computer system. The inventory specialist indicates completion of an item by depressing the switch or otherwise communicating using the module or the local computer. This communication also signals the system to move to the next item on the list and illuminate the reflector corresponding to the next item. The process is continued until each item on the list has been picked. A packing list is then printed and placed in the tote or in a shipping box with the items. The order is then sent to the customer.

All references, including publications, patent applications, and patents cited herein are hereby incorporated by reference to the same extent as if each reference were individually and specifically indicated to be incorporated by reference and were set forth in its entirety herein. The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless other wise indicated by context.

What is claimed is:

1. A light-directed inventory system, comprising:
a plurality of storage locations, each of said plurality of storage locations located at an assigned location;
optionally, a light reflector adjacent each of the plurality of storage locations;
a laser-light system configured for aiming a beam of visible light to each of storage locations or to each of the light reflectors; and
a computer system in communication with the laser-light system, the computer system configured to receive a list of items on an order and to aim the visible light at one storage location or reflector at a time, the reflector corresponding to a storage location with an item on the list of items of the order, wherein the storage locations and the optional light reflectors are configured for line-of-sight communication with the laser-light system.

2. The inventory system of claim 1, further comprising a device configured for sending or receiving information to the computer system concerning the order, the device selected from the group consisting of a switch, a personal digital assistant, a computer, and a transmitter with a microphone.

3. The inventory system of claim 1, wherein at least two of the storage locations comprise bins and further comprising a tote for the order.

4. The inventory system of claim 1, wherein the plurality of storage locations is arranged in rows and columns in a line.

5. The inventory system of claim 1, wherein the plurality of storage locations is arranged in a first array, and further comprising a second plurality of storage locations arranged in a second array and a second laser-light system configured for line-of-sight communication with each of the second plurality of storage locations, and further optionally comprising a plurality of reflectors, one reflector near or adjacent each storage location of the second plurality of storage locations, the optional light reflectors configured for line-of-sight communication with the second laser-light system.

6. The inventory system of claim 1, further comprising an electronic module corresponding to a plurality of the storage locations, the electronic module configured for displaying a quantity of items for picking, buttons for indicating a quantity of items picked or placed, and a task complete button

7. The inventory system of claim 1, wherein the laser light system comprises at least two stepper motors and at least one computer control for the stepper motors.

8. The inventory system of claim 1, wherein at least one of the plurality of storage locations contains a second plurality of containers, each of the second plurality of containers associated with an optional nearby reflector for illumination by the laser light system.

9. The inventory system of claim 1, wherein at least one of the plurality of storage locations contains a second plurality of containers, each of the second plurality of containers configured for line-of-sight communication with the laser-light system.

10. A light-directed inventory system, comprising:
a plurality of storage locations, each of said plurality of storage locations located at an assigned location in rows and columns in a horizontal and vertical array;
a light reflector adjacent each of the plurality of storage locations;
a laser-light system configured for aiming a beam of visible light to each of the light reflectors; and
a computer system in communication with the laser-light system, the computer system configured to receive a list of items on an order and to aim laser light system at one reflector at a time in the array, the reflector corresponding to an adjacent storage location with an item on the list of items of the order, wherein the storage locations and the light reflectors are configured for line-of-sight communication with the laser-light system.

11. The inventory system of claim 10, further comprising a device configured for sending or receiving information to the computer system concerning the order, the portable device selected from the group consisting of a module near the array, a personal digital assistant, a computer, and a transmitter with a microphone.

12. The inventory system of claim 10, wherein the aiming system comprises a stationary source of laser light and at least one mirror or prism for aiming the laser light.

13. The inventory system of claim 10, wherein at least one of the plurality of storage locations further comprises a second plurality of containers, each of the second plurality of containers associated with an optional nearby reflector for illumination by the laser light system.

14. A method for picking or placing items from an array of storage locations, the method comprising:
providing a tote for picking or placing items;
providing an array of storage locations holding items, each storage location in the array optionally having a light reflector adjacent the storage location;
providing a list of items and a quantity of each item on the list;
sending information to a computer system concerning a quantity of each item on the list of items;
operating a laser light system in communication with the computer system to direct visible laser light to a storage location holding an item on the list, or to the optional light reflector corresponding to the storage location; and
picking a desired quantity of items from the storage location and placing them into the tote, or placing a desired quantity of items from the tote into the storage location.

15. The method of claim 14, wherein the list of items comprises a plurality of items, and wherein the steps of operating and picking are accomplished for each item on the list of items.

16. The method of claim 14, further comprising communicating to the computer system that an item from the list of items has been picked or placed.

17. The method of claim 14, further comprising communicating to the computer system that an item from the list of items has been picked or placed, the communicating taking place with a device selected from the group consisting of a personal digital assistant, a computer, and a transmitter with a microphone.

18. The method of claim 14, wherein the laser light is directed with an aiming system using at least two stepper motors aiming the laser light source, or by manipulating at least one mirror or one prism to direct light from a stationary laser light source.

19. The method of claim 14, wherein the storage location to which laser light is directed further comprises a plurality of containers, and further comprising the step of operating the laser light system to direct laser light to one of the containers or to a reflector near one of the containers, wherein picking a desired quantity of items from the container comprises picking a desired quantity of items from the storage location for placing into the tote.

20. The method of claim 14, wherein at least one of the storage locations further comprises a plurality of storage locations, and wherein the step of operating the laser light system further comprises directing laser light to a door, a lid, or a reflector associated with one of the plurality of storage locations.
